(19) United States
(12) Patent Application Publication
(10) Pub. No.: US 2025/0095091 A1
(43) Pub. Date: Mar. 20, 2025

(54) AN ADAPTIVE STUDENT PERFORMANCE EVALUATION SYSTEM AND METHOD

(71) Applicant: Sufian Munir Inc., San Diego, CA (US)

(72) Inventors: ZAHID NISAR, Rawalpindi (PK); MUHAMMAD AETAZAZ SIDDIQI, Islamabad (PK); SUFIAN MUNIR, San Diego, CA (US)

(21) Appl. No.: 18/471,208

(22) Filed: Sep. 20, 2023

(51) Int. Cl. G06Q 50/20

(52) U.S. Cl. CPC G06Q 50/2053

(57) ABSTRACT

The embodiments herein provide a computer-implemented method and system for an adaptive student performance evaluation. The embodiments herein provide a method comprising the following steps: receiving, by an application server, an input data comprising student history, current study data, microphone input, camera input, teacher teaching methods, and learning path parameters from a user; providing, by the application server, the input data to a plurality of algorithms, including a clustering algorithm and a multi-output machine learning algorithm; and processing the input data by the plurality of algorithms to provide an output data to the user, such that the output data comprises teacher output including predicted recommendations for the teachers regarding course curation, lesson delivery, and student support; student output including predicted recommendations for the students regarding course selection, academic support, and learning paths; and system output including overall system recommendations and insights based on teacher and student predictions.

### BACKGROUND

### Technical Field

The embodiments herein are generally related to the field of learning systems and methods. The embodiments herein are particularly related to an adaptive student performance evaluation system and method. The embodiments herein are more particularly related to an adaptive student performance evaluation system and method to provide real-time feedback about the student's performance, ways to improve their lesson delivery, and also to provide the student's progress to their teachers over a period of time and help them in choosing best careers based on their areas of interest.

### Description of the Related Art

Instructional and teaching systems have been in existence for centuries, but their development has increased significantly with the development of the digital computer and more recently with the development of multimedia technology. Presently, computers have been implemented in the learning process in many ways. Systems that present a series of static lessons separated by a prompt-response testing procedure which determines whether a student will be allowed to progress to the next lesson or return to additional instruction on the tested subject in another format are known. These methods monitor student progress and disseminate additional information as the student progresses. Also known are learning systems with material indexed by type and degree of difficulty, where the system selects an appropriate lesson according to the user input and edits out parts of the lesson that are considered below the student's comprehension level. Other learning systems employ computer technology but are limited in scope to particular fields of instruction, such as instruction in the use of computer programs, or are limited in format to specific media, such as text and simulation exercises.

Some prior art learning systems utilize a static lesson format which is typically arranged in a predefined order. This format forces each student to conform to a particular lesson format, presented in a particular order, which may not fit his or her specific needs. Recently, attempts have been made to overcome the drawbacks of the prior art by using computer technology to implement learning systems that dynamically adjust to the ability of the student in order to improve and/or accelerate the learning process.

Furthermore, other drawbacks of using computer technology for imparting education include that teachers cannot statistically identify areas of interest or areas of weakness in particular students. Outside of exam performance, which might be altered by a number of factors, there is no way to statistically gauge a student's interest in a subject. In addition, in a classroom setting, the teacher often ends up being clueless about the engagement of a particular student and their content, simply because there are too many students in a single class. This results in an overall unoptimized classroom. Also, due to the gradual nature of most students' learning, and also a lack of context of the student's background, most teachers end up being completely unaware of a student's overall learning progression. This results in a disconnect between the teacher and the student since the teacher is only judging the student based on standardized criteria, which may not always be fair to the student.

Furthermore, the problems encountered by students include students often struggling while identifying career paths which might be of interest to them, because of a lack of awareness and guidance; many students struggle with studying by themselves due to a lack of guidance. That, combined with the aforementioned points regarding teaching methodology, results in an immense amount of difficulty for students in their attempts to understand even the simplest of topics at times. Also, the content for a particular subject doesn't suit a student's needs. For example, if a student barely passed fundamental geometry, something like Pythagoras' theorem might be difficult for them to understand, simply because they aren't good at the prerequisite. In these cases, it might be ideal to help them revise the necessary portions of the prerequisite subjects so that they might understand the subject better. Moreover, not all students learn the same way. Some students learn well when given theory, others learn visually, and others practically. However, in a class, all the students are taught the same way. This creates an inequitable environment since some people would be learning a lot more than others simply because the teaching methodology suits their way of learning.

Apart from the above-mentioned drawbacks, yet another problem that continues to persist is that of student engagement and a lack of student comprehension. Also, the lack of information on student performance in a classroom and an environment that is not optimized for learning. This causes students to learn very little, forget things very easily, engage less inside the classroom, and struggle with exam performance and eventually with their career choices. Hence, the problems of measuring student engagement and comprehension, and helping teachers make better decisions about the way they teach become very persistent.

Hence, in view of this, there is a need for a method and a system for an adaptive student performance evaluation, that provides real-time feedback about the students and their performance in the class, ways to improve lesson delivery by the teachers, monitoring the progress of the students over a period of time, and helping the students in making best decisions regarding their career.

The above-mentioned shortcomings, disadvantages, and problems are addressed herein, and will be understood by reading and studying the following specification.

### Objectives of the Embodiments Herein

The primary object of the embodiments herein is to provide an adaptive student performance evaluation system and method.

Another object of the embodiments herein is to provide a method and a system to measure and display student engagement status in real time.

Yet another object of the embodiments herein is to provide a method and a system for using the data collected by the system to help the teacher create an environment that is conducive to learning for all students, and not for some.

Yet another object of the embodiments herein is to provide a method and a system for adaptive student performance evaluation by improving a teacher's performance and efficiency by giving the teacher not only real-time statistical data of their classes but also methods to work around any difficulties that they might be facing.

Yet another object of the embodiments herein is to provide a system and method for helping students in finding ways to learn faster and more efficiently.

Yet another object of the embodiments herein is to provide a system and method for personalizing content for students so that all the students have an opportunity to learn to the best of their abilities.

Yet another object of the embodiments herein is to provide a system and method for helping students learn by themselves to improve their performance in class, and also discover more about their interests and dislikes.

Yet another object of the embodiments herein is to provide a system and method for aligning students to educational paths/journeys eventually translating into the right career options which match their interests and their temperaments, thus helping them be better in their professional careers.

These and other objects and advantages of the present invention will become readily apparent from the following detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

This Summary is provided to introduce a selection of concepts in a simplified form that is further described below in the Detailed Description. This Summary is not intended to identify key or essential features of the claimed subject matter, nor is it intended to be used as an aid in determining the scope of the claimed subject matter.

The various embodiments herein provide a computer-implemented method and system for an adaptive student performance evaluation. The embodiments herein provide a method comprising the following steps: receiving, by an application server, an input data comprising student history, current study data, microphone input, camera input, teacher teaching methods, and learning path parameters from a user; providing, by the application server, the input data to a plurality of algorithms, including a clustering algorithm and a multi-output machine learning algorithm; and processing the input data by the plurality of algorithms to provide an output data to the user, such that the output data comprises teacher output including predicted recommendations for the teachers regarding course curation, lesson delivery, and student support; student output including predicted recommendations for the students regarding course selection, academic support, and learning paths; and system output including overall system recommendations and insights based on teacher and student predictions.

According to one embodiment herein, a method for adaptive student performance evaluation is provided. The method comprises receiving, by an application server, an input data comprising student history, current study data, microphone input, camera input, teacher teaching methods, and learning path parameters from a user such as a teacher and student. The method further comprises providing, by the application server, the input data to a plurality of algorithms. The plurality of algorithms includes a clustering algorithm and a multi-output machine learning algorithm. Furthermore, the method comprises processing the input data by the plurality of algorithms to provide an output data, by the application server, to the user. The output data comprises teacher output, student output, and system output.

According to one embodiment herein, the student history includes previous subjects and topics covered; the current study data includes current subjects and topics being studied; the microphone input includes audio input from a microphone capturing the student's speech and/or tone, active talk time and/or class participation; the camera input includes visual input from a camera capturing student's facial expressions and/or body language; the teacher teaching methods include information on teacher's instructional strategies, approaches, and techniques; and the learning path parameters include user-defined parameters for learning path customization, including preferred subjects, interests and/or career goals.

According to one embodiment herein, the clustering algorithm is a Graph Neural Network (GNN)-based architecture, comprising a plurality of GNN layers configured to perform node representation learning, capturing the attributes and relationships of various entities in a graph structure. The graph structure comprises nodes and edges, such that the nodes comprises features including student, subject, topic, and/or teacher attributes; and the edges comprises relationships between the nodes. Furthermore, the graph structure helps to leverage the connections between subjects, topics, teachers, and students to gain insights into their educational journey.

According to one embodiment herein, the plurality of GNN layers comprises node features, aggregation, and node update. The node features include initial node feature representations, the aggregation includes neighborhood aggregation to gather information from connected nodes, and the node update includes update node representations based on the aggregated information.

According to one embodiment herein, the clustering algorithm further comprises a prelection layer including prelection features and prelection update. The prelection features include extracted features from a prelection data, including topic, teacher and/or performance, and the prelection update includes update prelection features based on the aggregated information. The prelection layer helps in processing the student's data, extracting relevant features that contribute to their learning profile, and these features are then combined with the node update of the plurality of GNN layers.

According to one embodiment herein, the clustering algorithm also comprises an unsupervised learning layer configured to uncover hidden patterns and structures of the data. The unsupervised learning layer employs techniques such as clustering or dimensionality reduction to derive meaningful latent representations.

According to one embodiment herein, the teacher output comprises predicted recommendations for teachers, including curated course content, optimal teaching methods, class summary, class attendance, overall class mood, average quiz results when applicable, and/or student engagement scores. The student output comprises predicted recommendations for students, including course selection, academic support, topics for self-learning, and/or future-most optimum academic track, including potential career path and its associated options. The future-most optimum academic track is accomplished by using a clustering and classification-based approach. Furthermore, the system output comprises valuable insights based on teacher and student predictions, and recommendations to optimize the learning environment and curriculum design.

According to one embodiment herein, the method for generating a future-most optimum academic track is provided. The method comprises collecting a dataset comprising a plurality of attributes, including student ID, topic/subject names, performance scores or grades, learning path labels, names of professions, historical performance data of various topics or subjects, quizzes, assignments, and/or subject attendance. The method further comprises pre-processing the dataset by handling missing values, removing outliers, and ensuring data consistency; and extracting features from the dataset to capture the student's performance in different topics. For instance, one can calculate each student's average scores or grades in each topic. Furthermore, the method comprises applying hierarchical clustering to identify meaningful clusters and learning paths of the extracted features of the students. The hierarchical clustering is to create a hierarchy of clusters based on the similarity of student's performance in different topics. In addition, appropriate linkage methods, such as single linkage, complete linkage, average linkage, and distance metrics based on the characteristics of the dataset. The method further comprises determining an optimal number of clusters that strikes a balance between granularity and interpretability, to understand the structure of the data and identify meaningful learning paths and topic groups. Moreover, the method comprises assigning cluster labels to each student based on the resulting cluster assignments; and training a classification model using the historical performance data and the assigned cluster labels as input features. The method further comprises evaluating the performance using appropriate evaluation metrics, including accuracy, precision, recall, F1-score, and/or area under the Receiver Operating Characteristic (ROC) curve (AUC-ROC), thus allowing to assess the effectiveness of the approach in predicting the learning paths and topic proficiencies. In addition, the method involves refining and fine-tuning hyperparameters, adjusting feature selection techniques, or exploring different clustering parameters. This is an iterative process to improve the predictive accuracy. Furthermore, the method involves predicting the learning paths and topic proficiencies of new students, by inputting the historical performance data, obtaining predictions, and using the assigned cluster labels to recommend suitable learning paths or topic groups based on the predicted outcomes. The method further involves continuously updating and retraining the method as new data becomes available; and incorporating feedback and monitoring to ensure effectiveness in predicting the learning paths and topic proficiencies based on historical performance data.

According to one embodiment herein, a computer-implemented system for adaptive student performance evaluation is provided. The system comprises an input module configured to acquire an input data comprising student history, current study data, microphone input, camera input, teacher teaching methods, and learning path parameters from a user. The user includes a teacher and a student. The system further comprises an application server configured to receive the input data from the input module. In addition, the system comprises a multi-output algorithmic module comprising a plurality of algorithms including a clustering algorithm and a multi-output machine learning algorithm, configured to obtain the input data from the application server and process the input data to provide an output data to the user. Furthermore, the system comprises an output data module configured to receive the output data from the application server, and to provide the output data comprising a teacher output, a student output, and a system output.

According to one embodiment herein, the student history includes previous subjects and topics covered; the current study data includes current subjects and topics being studied; the microphone input includes audio input from a microphone capturing the student's speech and/or tone, active talk time and/or class participation; the camera input includes visual input from a camera capturing student's facial expressions and/or body language; the teacher teaching methods include information on teacher's instructional strategies, approaches and techniques; and the learning path parameters include user-defined parameters for learning path customization, including preferred subjects, interests and/or career goals.

According to one embodiment herein, the clustering algorithm of the multi-output algorithmic module is a Graph Neural Network (GNN)-based architecture, comprising a plurality of GNN layers configured to perform node representation learning, capturing the attributes and relationships of various entities in a graph structure. The graph structure comprises nodes and edges such that the nodes comprise features including student, subject, topic, and/or teacher attributes, and the edges comprise relationships between the nodes.

According to one embodiment herein, the plurality of GNN layers comprise node features, aggregation, and node update. The node features include initial node feature representations. The aggregation includes neighborhood aggregation to gather information from connected nodes, and the node update includes update node representations based on the aggregated information.

According to one embodiment herein, the clustering algorithm of the multi-output algorithmic module further comprises a prelection layer including prelection features and prelection update. The prelection features include extracted features from prelection data, including topic, teacher, and/or performance, and the prelection update includes updated prelection features based on the aggregated information. The prelection layer helps in processing the student's data, extracting relevant features that contribute to their learning profile, and these features are then combined with the node update of the plurality of GNN layers.

According to one embodiment herein, the clustering algorithm of the multi-output algorithmic module also comprises an unsupervised learning layer configured to uncover hidden patterns and structures of the data, and employing techniques, including clustering or dimensionality reduction to derive meaningful latent representations.

According to one embodiment herein, the teacher output comprises predicted recommendations for teachers, including curated course content, optimal teaching methods, class summary, class attendance, overall class mood, average quiz results when applicable, and/or student engagement scores. Further, the student output comprises predicted recommendations for students, including course selection, academic support, topics for self-learning, and/or future-most optimum academic track, including potential career path and their associated options. The future-most optimum academic track is accomplished by using a clustering and classification-based approach. Furthermore, the system output comprises valuable insights based on teacher and student predictions, and recommendations to optimize the learning environment and curriculum design.

According to one embodiment herein, the method for generating a future-most optimum academic track by the output module is provided. The method comprises collecting a dataset comprising a plurality of attributes, including student ID, topic/subject names, performance scores or grades, learning path labels, names of professions, historical performance data of various topics or subjects, quizzes, assignments, and/or subject attendance. The method further comprises pre-processing the dataset by handling missing values, removing outliers, and ensuring data consistency; and extracting features from the dataset to capture the student's performance in different topics. For instance, one can calculate each student's average scores or grades in each topic. Furthermore, the method comprises applying hierarchical clustering to identify meaningful clusters and learning paths of the extracted features of the students. The hierarchical clustering is to create a hierarchy of clusters based on the similarity of student's performance in different topics. In addition, appropriate linkage methods, such as single linkage, complete linkage, average linkage, and distance metrics based on the characteristics of the dataset. The method further comprises determining an optimal number of clusters that strikes a balance between granularity and interpretability, to understand the structure of the data and identify meaningful learning paths and topic groups. Moreover, the method comprises assigning cluster labels to each student based on the resulting cluster assignments; and training a classification model using the historical performance data and the assigned cluster labels as input features. The method further comprises evaluating the performance using appropriate evaluation metrics, including accuracy, precision, recall, F1-score, and/or area under the Receiver Operating Characteristic (ROC) curve (AUC-ROC), thus allowing to assess the effectiveness of the approach in predicting the learning paths and topic proficiencies. In addition, the method involves refining and fine-tuning hyperparameters, adjusting feature selection techniques, or exploring different clustering parameters. This is an iterative process to improve the predictive accuracy. Furthermore, the method involves predicting the learning paths and topic proficiencies of new students, by inputting the historical performance data, obtaining predictions, and using the assigned cluster labels to recommend suitable learning paths or topic groups based on the predicted outcomes. The method further involves continuously updating and retraining the method as new data becomes available; and incorporating feedback and monitoring to ensure effectiveness in predicting the learning paths and topic proficiencies based on historical performance data.

The foregoing summary is illustrative only and is not intended to be in any way limiting. In addition to the illustrative aspects, embodiments, and features described above, further aspects, embodiments, and features will become apparent by reference to the drawings and the following detailed description.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a flowchart depicting a method for an adaptive student performance evaluation, according to one embodiment herein.

FIG. 2 depicts a computer-implemented system for an adaptive student performance evaluation, according to one embodiment herein.

FIG. 3 illustrates an architectural block diagram of the system for an adaptive student performance evaluation, according to an embodiment herein.

FIG. 4 illustrates a method for generating a future-most optimum academic track, according to an embodiment herein.

FIG. 5A illustrates a graph on an example of the cluster for course curation, according to an embodiment herein.

FIG. 5B illustrates a neural network for optimal teaching methodology, according to an embodiment herein.

FIG. 5C illustrates a neural network for subject fluency for students, according to an embodiment herein.

FIG. 5D illustrates a cluster for areas of interest, according to an embodiment herein.

FIG. 5E illustrates a neural network for career path recommendations, according to an embodiment herein.

Although the specific features of the present invention are shown in some drawings and not in others. This is done for convenience only as each feature may be combined with any or all of the other features in accordance with the present invention.

### DETAILED DESCRIPTION OF THE EMBODIMENTS HEREIN

In the following detailed description, reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical, and other changes may be made without departing from the scope of the embodiments. The following detailed description is therefore not to be taken in a limiting sense.

The foregoing of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

The various embodiments herein provide a computer-implemented method and system for an adaptive student performance evaluation. The embodiments herein provide a method comprising the following steps: receiving, by an application server, an input data comprising student history, current study data, microphone input, camera input, teacher teaching methods, and learning path parameters from a user; providing, by the application server, the input data to a plurality of algorithms, including a clustering algorithm and a multi-output machine learning algorithm; and processing the input data by the plurality of algorithms to provide an output data to the user, such that the output data comprises teacher output including predicted recommendations for the teachers regarding course curation, lesson delivery, and student support; student output including predicted recommendations for the students regarding course selection, academic support, and learning paths; and system output including overall system recommendations and insights based on teacher and student predictions.

According to one embodiment herein, a method for adaptive student performance evaluation is provided. The method comprises receiving, by an application server, an input data comprising student history, current study data, microphone input, camera input, teacher teaching methods, and learning path parameters from a user such as a teacher and student. The method further comprises providing, by the application server, the input data to a plurality of algorithms. The plurality of algorithms includes a clustering algorithm and a multi-output machine learning algorithm. Furthermore, the method comprises processing the input data by the plurality of algorithms to provide an output data, by the application server, to the user. The output data comprises teacher output, student output, and system output.

According to one embodiment herein, the student history includes previous subjects and topics covered; the current study data includes current subjects and topics being studied; the microphone input includes audio input from a microphone capturing the student's speech and/or tone, active talk time and/or class participation; the camera input includes visual input from a camera capturing student's facial expressions and/or body language; the teacher teaching methods include information on teacher's instructional strategies, approaches, and techniques; and the learning path parameters include user-defined parameters for learning path customization, including preferred subjects, interests and/or career goals.

In particular, the previous subjects and topics covered are important as the performance of the students and their understanding of the next subjects and topics depends on it. So, for the teacher, it is important to understand the subjects the students are familiar with, as well as new. Furthermore, current subjects and topics being studied by the students are also paramount because certain students are interested in certain subjects, and there are other students who learn the subject incredibly well simply because of the teaching methodology implied by the teacher. The method thus also considers the subject being taught, and the teacher who teaches it. This strategy helps to draw a behavioral pattern of the student, showing the information about the student's aptitude and the teaching methods that work best for the student. The behavioral pattern of the student is a collection of information regarding what is considered to be “normal” behavior for a student, and the state in which a student is most comfortable. For example, some students may not perform exceptionally well whilst being in a very responsive classroom, where counter-questioning is the norm, but would thrive in classes that work on more of a “give lecture first, ask questions later” approach. This method would save the student's tendency towards introversion in itself, and use it in the future in order to guide both the student and the teacher towards a more efficient learning environment. In addition, to the above, the student's body language, gestures, speaking time, tone, and expressions also give a good degree of understanding of how attentive or engaged a student is inside the classroom. The method uses a camera and a microphone either from the student's device or installed inside the classroom to evaluate a student's body language, including posture, head movements, facial expressions etc., gestures such as hand raises, head nods etc., and speaking time is measured through microphone input and filtered to include only relevant speaking time to provide an estimate of engagement. These variables will be measured at a frequency optimized for the network, system configuration, manual intervention by the institute's administration and the privacy policies in place to help measure the student engagement and attentiveness during any given lesson.

Furthermore, the teacher teaching methods include information on teacher's instructional strategies, approaches, and techniques used by the teacher to teach the students, and how the students perform. This helps the system create a relationship between the teacher/teaching method and the students' learning, which can be used to inform teachers down the line regarding the approach that would work best for the particular student. In addition, the personal information of the students is also considered, which refers to student biodata, including but not limited to the student's parental information, living address, ethnicity, gender, and age. At times the background also explains a student's behavior and even the reasons behind a change in their performance in school. This would help the teachers to be more empathetic towards students and to figure out the reason behind the performance drop in students.

According to one embodiment herein, the clustering algorithm is a Graph Neural Network (GNN)-based architecture, comprising a plurality of GNN layers configured to perform node representation learning, capturing the attributes and relationships of various entities in a graph structure. The graph structure comprises nodes and edges, such that the nodes comprises features including student, subject, topic, and/or teacher attributes; and the edges comprises relationships between the nodes. Furthermore, the graph structure helps to leverage the connections between subjects, topics, teachers, and students to gain insights into their educational journey.

According to one embodiment herein, the plurality of GNN layers comprises node features, aggregation, and node update. The node features include initial node feature representations, the aggregation includes neighborhood aggregation to gather information from connected nodes, and the node update includes update node representations based on the aggregated information.

According to one embodiment herein, the clustering algorithm further comprises a prelection layer including prelection features and prelection update. The prelection features include extracted features from prelection data, including topic, teacher, and/or performance, and the prelection update includes updated prelection features based on the aggregated information. The prelection layer helps in processing the student's data, extracting relevant features that contribute to their learning profile, and these features are then combined with the node update of the plurality of GNN layers. Furthermore, the topic can be the subject or theme of the lecture or course, the teacher includes information about the instructor, such as qualifications, expertise, teaching style, etc. The performance can be the metrics or data related to the effectiveness or success of the teaching, perhaps including student performance, feedback, or other evaluative measures. Moreover, the clustering algorithm can also include various student and teacher attributes and behaviors to form clusters or groups, which could be used for personalized recommendations or to uncover underlying patterns in the learning environment.

According to one embodiment herein, the clustering algorithm also comprises an unsupervised learning layer configured to uncover hidden patterns and structures of the data, including information related to lectures or instructional content. The unsupervised learning layer employs techniques such as clustering or dimensionality reduction to derive meaningful latent representations. The unsupervised learning layer can have larger sets of student performance, class interaction, or other educational data that can be mined for hidden patterns and structures.

According to one embodiment herein, the teacher output comprises predicted recommendations for teachers, including curated course content, optimal teaching methods, class summary, class attendance, overall class mood, average quiz results when applicable, and/or student engagement scores. The student output comprises predicted recommendations for students, including course selection, academic support, topics for self-learning, and/or future-most optimum academic track, including potential career path and its associated options. The future-most optimum academic track is accomplished by using a clustering and classification-based approach. Furthermore, the system output comprises valuable insights based on teacher and student predictions, and recommendations to optimize the learning environment and curriculum design.

The course content is curated for each course in accordance with the interest and potential of each student, using the multi-output machine learning algorithm. The student's history, more precisely the subjects and the topics the student has previously studied, the teacher under whom they studied a particular topic or subject, and the student's performance is fed to the multi-output machine learning algorithm to obtain the curated course content. Furthermore, the optimal teaching methodology is used to describe the most efficient way of teaching a student in which the student is most engaged and performs best. For determining optimal teaching methodology, a multitude of parameters is considered, including facial expressions, the topic and subject being taught to the student, their past performance in that particular subject, alongside how the student was previously taught the subject. The multi-output machine learning algorithm, based on historical data, provides the approach or methodology of teaching trends that work best for the particular student. In addition, the behavioral approach is also considered for obtaining optimal teaching methodology, by taking the behavioral profiles of the students to form a cluster, and then the cluster is analyzed to view the best-performing students from one particular behavioral group being taught and recommend it to the teacher. This would help a teacher in determining the approach that suits best for the students.

In addition, the performance in quizzes, assignments, and exams, alongside the performance of the student in the past in the same subject is used to determine the fluency of a particular student in a particular subject. The fluency/mastery rating helps to provide the teacher's expectations from the student and will also help them in making decisions about how the teachers would want to approach teaching that student so that they could work their way up to the mark by the time the teacher's teaching tenure for that student ends. Furthermore, the student's areas of interest help the students to decide about their educational journey and eventually a career path. In order to find out about a student's areas of interest, an observation-based approach is followed. The hypothesis is that if a student is truly interested in a subject, the student would pay more attention in the classes where that subject is taught, ask more questions due to an increased curiosity regarding the subject, study the subject by themselves, and perform better in the subject in comparison to how they do in other subjects. Hence, in order to spot a student's area of interest, the multi-output machine learning algorithm is provided with student's body language, the topic they're studying, their academic performance in the topic, the amount of self-study the student puts into the topic, and the audio to check if the students ask any questions about the topic. The multi-output machine learning algorithm takes in the information and generates an interest rating for the student on that particular topic. Then, based on the cluster of topics, the method also predicts the student's interest in other topics of the subject.

Moreover, one of the most prevalent challenges encountered by students is the identification of suitable career paths that align with their interests, skills, and aspirations. This predicament extends beyond mere financial considerations and encompasses the search for personal fulfillment and purpose in their lives. To address this issue, the embodiments herein provide career recommendations by leveraging statistical analysis, student profiling, and behavioral data. The embodiments herein operate through a sophisticated neural network architecture, or the plurality of algorithms designed for career path recommendations. The embodiments herein maintain an extensive repository of potential careers, each associated with specific domains of expertise and personality traits required for success in those fields. Leveraging this knowledge base, the embodiments herein utilize advanced algorithms to analyze student data, including their areas of interest and behavioral patterns. Hence, by employing the clustering algorithm, the embodiments herein compare the student's data directly against the predefined list of careers. This comparative analysis enables the embodiments herein to generate a comprehensive list of the future-most optimum academic track, including potential career paths and their associated options tailored to the individual student's profile.

Furthermore, the embodiments herein also provide self-study method recommendations for the students. Students who spend a small amount of time learning by themselves alongside taking their school classes show a tendency to achieve improved results. Thus, in order to improve student performance, the teachers help in creating an environment where students learn more effectively and are intrigued enough to study things at home, while also helping other students when they study for themselves. For providing self-study method recommendations for the students, the embodiments take in information about students' past performance, their body language in class, their interests, the past teaching methodologies they've studied under, and the teacher's teaching methodology. Based on the information, the embodiments herein request the teacher to teach the student in ways that have, in the past, shown themselves to be more effective for that particular student. When the data is fed to the multi-output machine learning algorithm, the algorithm will return to the teacher ways to make the student more interested in the topic, while to the student during self-study, the algorithm will give ways to make their own learning easier and more interesting.

According to one embodiment herein, the method for generating a future-most optimum academic track is provided. The method comprises collecting a dataset comprising a plurality of attributes, including student ID, topic/subject names, performance scores or grades, learning path labels, names of professions, historical performance data of various topics or subjects, quizzes, assignments, and/or subject attendance. The method further comprises pre-processing the dataset by handling missing values, removing outliers, and ensuring data consistency; and extracting features from the dataset to capture the student's performance in different topics. For instance, one can calculate each student's average scores or grades in each topic. Furthermore, the method comprises applying hierarchical clustering to identify meaningful clusters and learning paths of the extracted features of the students. The hierarchical clustering is to create a hierarchy of clusters based on the similarity of student's performance in different topics. In addition, appropriate linkage methods, such as single linkage, complete linkage, average linkage, and distance metrics based on the characteristics of the dataset. The method further comprises determining an optimal number of clusters that strikes a balance between granularity and interpretability, to understand the structure of the data and identify meaningful learning paths and topic groups. Moreover, the method comprises assigning cluster labels to each student based on the resulting cluster assignments; and training a classification model using the historical performance data and the assigned cluster labels as input features. The method further comprises evaluating the performance using appropriate evaluation metrics, including accuracy, precision, recall, F1-score, and/or area under the Receiver Operating Characteristic (ROC) curve (AUC-ROC), thus allowing to assess the effectiveness of the approach in predicting the learning paths and topic proficiencies. In addition, the method involves refining and fine-tuning hyperparameters, adjusting feature selection techniques, or exploring different clustering parameters. This is an iterative process to improve the predictive accuracy. Furthermore, the method involves predicting the learning paths and topic proficiencies of new students, by inputting the historical performance data, obtaining predictions, and using the assigned cluster labels to recommend suitable learning paths or topic groups based on the predicted outcomes. The method further involves continuously updating and retraining the method as new data becomes available; and incorporating feedback and monitoring to ensure effectiveness in predicting the learning paths and topic proficiencies based on historical performance data.

According to one embodiment herein, a computer-implemented system for adaptive student performance evaluation is provided. The system comprises an input module configured to acquire an input data comprising student history, current study data, microphone input, camera input, teacher teaching methods, and learning path parameters from a user. The user includes a teacher and a student. The system further comprises an application server configured to receive the input data from the input module. In addition, the system comprises a multi-output algorithmic module comprising a plurality of algorithms including a clustering algorithm and a multi-output machine learning algorithm, configured to obtain the input data from the application server and process the input data to provide an output data to the user. Furthermore, the system comprises an output data module configured to receive the output data from the application server, and to provide the output data comprising a teacher output, a student output, and a system output.

According to one embodiment herein, the student history includes previous subjects and topics covered; the current study data includes current subjects and topics being studied; the microphone input includes audio input from a microphone capturing the student's speech and/or tone, active talk time and/or class participation; the camera input includes visual input from a camera capturing student's facial expressions and/or body language; the teacher teaching methods include information on teacher's instructional strategies, approaches and techniques; and the learning path parameters include user-defined parameters for learning path customization, including preferred subjects, interests and/or career goals.

According to one embodiment herein, the clustering algorithm of the multi-output algorithmic module is a Graph Neural Network (GNN)-based architecture, comprising a plurality of GNN layers configured to perform node representation learning, capturing the attributes and relationships of various entities in a graph structure. The graph structure comprises nodes and edges such that the nodes comprise features including student, subject, topic, and/or teacher attributes, and the edges comprise relationships between the nodes.

According to one embodiment herein, the plurality of GNN layers comprise node features, aggregation, and node update. The node features include initial node feature representations. The aggregation includes neighborhood aggregation to gather information from connected nodes, and the node update includes update node representations based on the aggregated information.

According to one embodiment herein, the clustering algorithm of the multi-output algorithmic module further comprises a prelection layer including prelection features and prelection update. The prelection features include extracted features from prelection data, including topic, teacher, and/or performance, and the prelection update includes updated prelection features based on the aggregated information. The prelection layer helps in processing the student's data, extracting relevant features that contribute to their learning profile, and these features are then combined with the node update of the plurality of GNN layers.

According to one embodiment herein, the clustering algorithm of the multi-output algorithmic module also comprises an unsupervised learning layer configured to uncover hidden patterns and structures of the data, including information related to lectures or instructional content, and employing techniques, including clustering or dimensionality reduction to derive meaningful latent representations.

According to one embodiment herein, the teacher output comprises predicted recommendations for teachers, including curated course content, optimal teaching methods, class summary, class attendance, overall class mood, average quiz results when applicable, and/or student engagement scores. Further, the student output comprises predicted recommendations for students, including course selection, academic support, topics for self-learning, and/or future-most optimum academic track, including potential career path and its associated options. The future-most optimum academic track, is accomplished by using a clustering and classification-based approach. Furthermore, the system output comprises valuable insights based on teacher and student predictions, and recommendations to optimize the learning environment and curriculum design.

According to one embodiment herein, the method for generating a future-most optimum academic track by the output module is provided. The method comprises collecting a dataset comprising a plurality of attributes, including student ID, topic/subject names, performance scores or grades, learning path labels, names of professions, historical performance data of various topics or subjects, quizzes, assignments, and/or subject attendance. The method further comprises pre-processing the dataset by handling missing values, removing outliers, and ensuring data consistency; and extracting features from the dataset to capture the student's performance in different topics. For instance, one can calculate each student's average scores or grades in each topic. Furthermore, the method comprises applying hierarchical clustering to identify meaningful clusters and learning paths of the extracted features of the students. The hierarchical clustering is to create a hierarchy of clusters based on the similarity of student's performance in different topics. In addition, appropriate linkage methods, such as single linkage, complete linkage, average linkage, and distance metrics based on the characteristics of the dataset. The method further comprises determining an optimal number of clusters that strikes a balance between granularity and interpretability, to understand the structure of the data and identify meaningful learning paths and topic groups. Moreover, the method comprises assigning cluster labels to each student based on the resulting cluster assignments; and training a classification model using the historical performance data and the assigned cluster labels as input features. The method further comprises evaluating the performance using appropriate evaluation metrics, including accuracy, precision, recall, F1-score, and/or area under the Receiver Operating Characteristic (ROC) curve (AUC-ROC), thus allowing to assess the effectiveness of the approach in predicting the learning paths and topic proficiencies. In addition, the method involves refining and fine-tuning hyperparameters, adjusting feature selection techniques, or exploring different clustering parameters. This is an iterative process to improve the predictive accuracy. Furthermore, the method involves predicting the learning paths and topic proficiencies of new students, by inputting the historical performance data, obtaining predictions, and using the assigned cluster labels to recommend suitable learning paths or topic groups based on the predicted outcomes. The method further involves continuously updating and retraining the method as new data becomes available; and incorporating feedback and monitoring to ensure effectiveness in predicting the learning paths and topic proficiencies based on historical performance data.

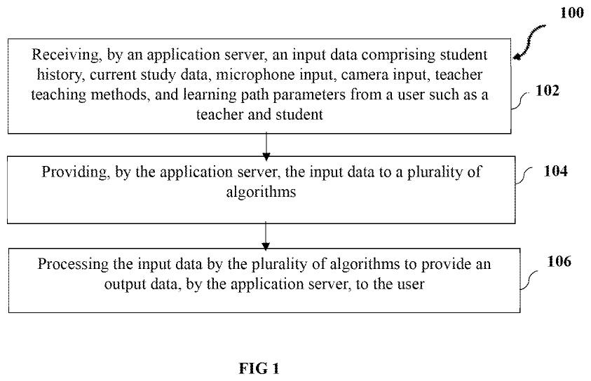

FIG. 1 illustrates a flowchart depicting a method for an adaptive student performance evaluation, according to one embodiment herein. The method 100 comprises receiving, by an application server, an input data comprising student history, current study data, microphone input, camera input, teacher teaching methods, and learning path parameters from a user such as a teacher and student at step 102. The method 100 further comprises providing, by the application server, the input data to a plurality of algorithms at step 104. The plurality of algorithms includes a clustering algorithm and a multi-output machine learning algorithm. Furthermore, the method 100 comprises processing the input data by the plurality of algorithms to provide an output data, by the application server, to the user at step 106. The output data comprises teacher output, student output, and system output.

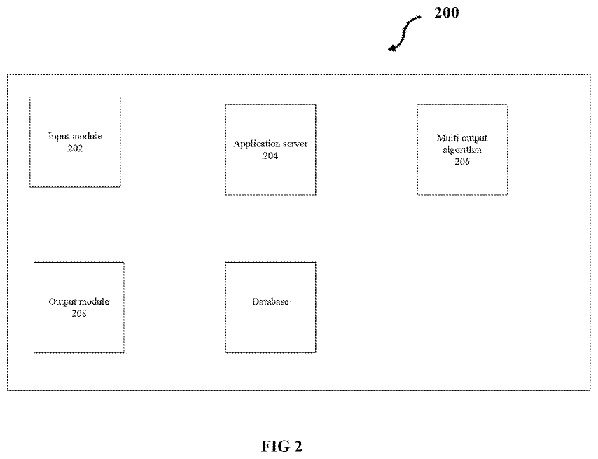

FIG. 2 depicts a computer-implemented system for an adaptive student performance evaluation, according to one embodiment herein. The system 200 comprises an input module 202 configured to acquire an input data comprising student history, current study data, microphone input, camera input, teacher teaching methods, and learning path parameters from a user. The user includes a teacher and a student. The system 200 further comprises an application server 204 configured to receive the input data from the input module 202. In addition, the system 200 comprises a multi-output algorithmic module 206 comprising a plurality of algorithms including a clustering algorithm and a multi-output machine learning algorithm, configured to obtain the input data from the application server 204 and process the input data to provide an output data to the user. Furthermore, the system 200 comprises an output data module 208 configured to receive the output data from the application server 204, and to provide the output data comprising a teacher output, a student output, and a system output.

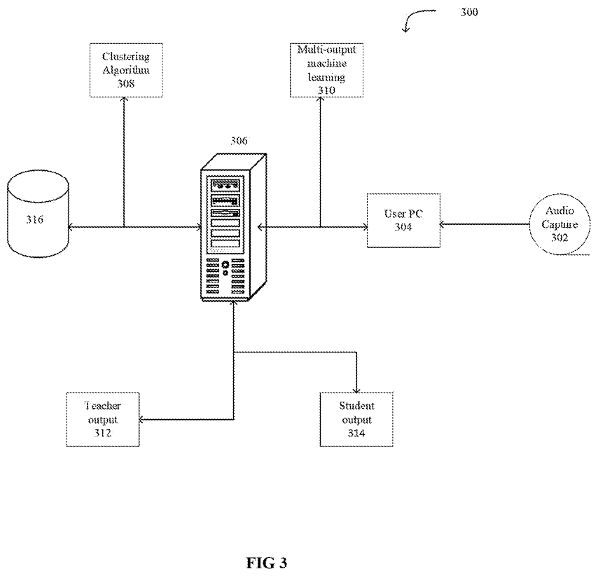

FIG. 3 illustrates an architectural block diagram of the system for an adaptive student performance evaluation, according to an embodiment herein. The system 300 comprises an application server 306, a clustering algorithm 308, a multi-output machine learning algorithm 310, a database 316, a teacher output 312 and a student output 314. The system 300 is in communication with a User PC 304, configured to obtain audio and video input 302. The application server 306 is configured to host the application, and the users communicate when the user needs to access the system 300. The application server 306 is configured to obtain the data from the user's end and feed it into the clustering algorithm 308 (GNNs for graphs) and multi-output machine learning algorithm 310, in order to get the desired outputs for the users. Once the output is obtained, the application server 306 forwards the output data onto the student output 314 and the teacher output 312 dashboards, and also saves the output data in the database 316 for future reference, and to generate more accurate results for things like areas of interest and career path. The database 316 also holds within itself the student and the teacher information in order to maintain a holistic record of the characteristics of both the students and the teachers.

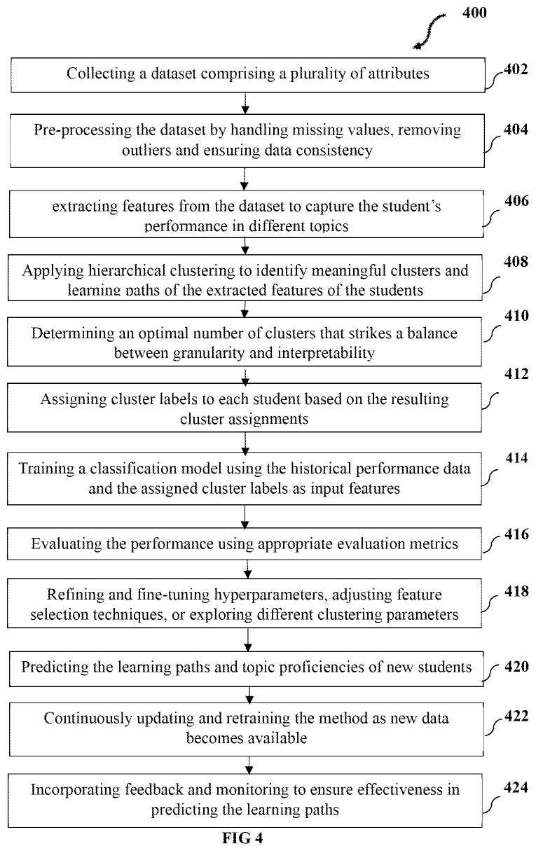

FIG. 4 illustrates a method for generating a future-most optimum academic track, according to an embodiment herein. The method 400 comprises collecting a dataset comprising a plurality of attributes, including student ID, topic/subject names, performance scores or grades, learning path labels, names of professions, historical performance data of various topics or subjects, quizzes, assignments, and/or subject attendance at step 402. The method 400 further comprises pre-processing the dataset by handling missing values, removing outliers, and ensuring data consistency at step 404; and extracting features from the dataset to capture the student's performance in different topics at step 406. For instance, one can calculate each student's average scores or grades in each topic. Furthermore, the method 400 comprises applying hierarchical clustering to identify meaningful clusters and learning paths of the extracted features of the students at step 408. The hierarchical clustering is to create a hierarchy of clusters based on the similarity of student's performance in different topics. In addition, appropriate linkage methods, such as single linkage, complete linkage, average linkage, and distance metrics based on the characteristics of the dataset. The method 400 further comprises determining an optimal number of clusters that strikes a balance between granularity and interpretability, to understand the structure of the data and identify meaningful learning paths and topic groups at step 410. Moreover, the method 400 comprises assigning cluster labels to each student based on the resulting cluster assignments 412; and training a classification model using the historical performance data and the assigned cluster labels as input features at step 414. The method 400 further comprises evaluating the performance using appropriate evaluation metrics, including accuracy, precision, recall, F1-score, and/or area under the Receiver Operating Characteristic (ROC) curve (AUC-ROC) at step 416, thus allowing to assess the effectiveness of the approach in predicting the learning paths and topic proficiencies. In addition, the method 400 involves refining and fine-tuning hyperparameters, adjusting feature selection techniques, or exploring different clustering parameters at step 418. This is an iterative process to improve the predictive accuracy. Furthermore, the method 400 involves predicting the learning paths and topic proficiencies of new students, by inputting the historical performance data, obtaining predictions, and using the assigned cluster labels to recommend suitable learning paths or topic groups based on the predicted outcomes at step 420. The method 400 further involves continuously updating and retraining the method as new data becomes available at step 422; and incorporating feedback and monitoring to ensure effectiveness in predicting the learning paths and topic proficiencies based on historical performance data at step 424.

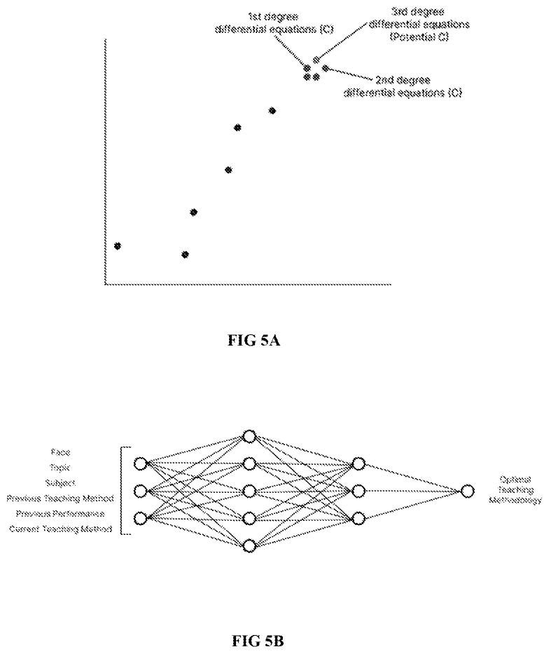

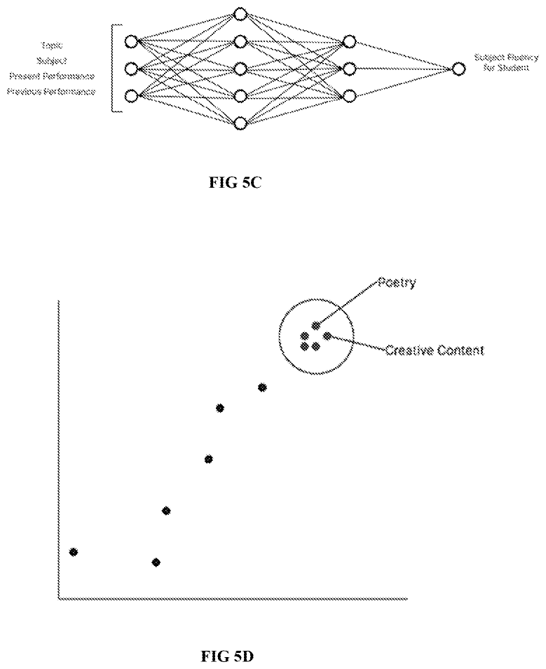

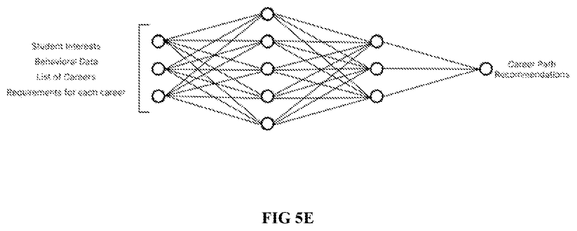

FIG. 5A illustrates a graph on an example of the cluster for course curation, according to an embodiment herein. FIG. 5A illustrates an example of the cluster for course curation. The graph illustrates, for example, considering that a Student A is not performing well in 3rd-degree differential equations. The embodiments herein would take this information, and check how they performed in the prerequisite topics, including 1st and 2^{nd}-degree differential equations. If the student had performed well in those, the embodiments would recommend to the student to learn 3^{rd}-degree differential equations using methods similar to the methods they used in learning 1st and 2^{nd}-degree differential equations. If the student struggled with the prerequisites as well, the system would suggest the student to revise the previous topic and then take a quick assessment so that they can perform better in the future topics.

FIG. 5B illustrates a neural network for optimal teaching methodology, according to an embodiment herein. The optimal teaching methodology is used to describe the most efficient way of teaching a student in which the student is most engaged and performs best. For determining optimal teaching methodology, a multitude of parameters is considered, including facial expressions, the topic and subject being taught to the student, their past performance in that particular subject, alongside how the student was previously taught the subject. The multi-output machine learning algorithm, based on historical data, provides the approach or methodology of teaching trends that work best for the particular student. In addition, the behavioral approach is also considered for obtaining optimal teaching methodology, by taking the behavioral profiles of the students to form a cluster, and then the cluster is analyzed to view the best-performing students from one particular behavioral group being taught and recommend it to the teacher. This would help a teacher in determining the approach that suits best for the students. considering an example of this in FIG. 5B, student A, studying in 7th grade, shows introversion in his behavior, and struggles in Algebra. The embodiments herein can help this student and the teacher by sifting through past data and understanding how other students with similar behavior profiles studying the same subject performed well, and the methods both the teacher and the student can apply in order to improve the student's performance in algebra. Considering that the method worked for other students exhibiting the same behavior in the same subject, it should work for student A as well.

FIG. 5C illustrates a neural network for subject fluency for students, according to an embodiment herein. FIG. 5C illustrates the neural network, providing the topic, subject, previous and past performance, the system provides the information to the teacher, that if a student is very fluent, average, or below average in a particular subject. The teacher will also be able to assess the student by themselves and dictate their own observations to the system. Consider an example, student A who has shown great results in linear algebra, both in present and in past. The teacher also believes that the student is doing his work with honesty, and thus is surpassing all average expectations in the subject. The embodiments herein, taking all this information into account, would declare that the student is fluent in linear algebra, and based on this information, make other decisions as well.

FIG. 5D illustrates a cluster for areas of interest, according to an embodiment herein. The student's areas of interest help the students to decide about their educational journey and eventually a career path. In order to find out about a student's areas of interest, an observation-based approach is followed. FIG. 5D illustrates the cluster for areas of interest with an example. Consider s student A is interested in poetry, and in the English subject, poetry, prose, songwriting, and creative content writing for marketing are very close together in the cluster, the embodiments herein predicts that the student might be interested in prose, songwriting, and creative content writing as well.

FIG. 5E illustrates a neural network for career path recommendations, according to an embodiment herein. One of the most prevalent challenges encountered by students is the identification of suitable career paths that align with their interests, skills, and aspirations. This predicament extends beyond mere financial considerations and encompasses the search for personal fulfillment and purpose in their lives. To address this issue, the embodiments herein provide career recommendations by leveraging statistical analysis, student profiling, and behavioral data. FIG. 5E illustrates the system's functionality, considering Student A as an example. Throughout their academic journey, Student A has consistently demonstrated introverted tendencies, exceptional problem-solving capabilities, and a profound interest in mathematics, particularly in the domains of algebra and calculus. Based on the accumulated data, the embodiments herein has learned that individuals exhibiting these characteristics often exhibit a strong inclination towards STEM fields, with a specific emphasis on software engineering.

It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

While the disclosure is susceptible to various modifications and alternative forms, specific embodiment thereof has been shown by way of example in the drawings and will be described in detail above. It should be understood, however, that it is not intended to limit the disclosure to the forms disclosed, but on the contrary, the disclosure is to cover all modifications, equivalents, and alternatives falling within the scope of the disclosure.

The embodiments herein disclose a computer-implemented system and method for an adaptive student performance evaluation. The embodiments herein demonstrates a novel approach to leveraging GNNs, prelection data, and unsupervised learning techniques to provide tailored recommendations for teachers and students. The embodiments herein provide these recommendations, with an aim to enhance student engagement, comprehension, and academic performance while assisting teachers in making informed decisions about their teaching methodologies. Furthermore, the embodiments herein offers a unique solution to address the persistent challenges of student engagement and comprehension in education by providing real-time feedback, progress tracking, and personalized learning opportunities based on individual needs and interests.

Although the embodiments herein are described with various specific embodiments, it will be obvious for a person skilled in the art to practice the embodiments herein with modifications.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments.

It is to be understood that the phrases or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. A method (100) for adaptive student performance evaluation, the method comprises:
a. receiving, by an application server, an input data comprising student history, current study data, microphone input, camera input, teacher teaching methods, and learning path parameters from a user (102); and wherein the user includes a teacher and a student;
b. providing, by the application server, the input data to a plurality of algorithms; and
wherein the plurality of algorithms include a clustering algorithm and a multi-output machine learning algorithm (104); and
c. processing the input data by the plurality of algorithms to provide an output data, by the application server, to the user (106); and wherein the output data comprises a teacher output, a student output, and a system output.

2. The method (100) according to claim 1, wherein the student history includes previous subjects and topics covered; and wherein the current study data includes current subjects and topics being studied; and wherein the microphone input includes audio input from a microphone capturing the student's speech and/or tone, active talk time and/or class participation; and wherein the camera input includes visual input from a camera capturing student's facial expressions and/or body language; and wherein the teacher teaching methods include information on teacher's instructional strategies, approaches and techniques; and wherein the learning path parameters include user-defined parameters for learning path customization, including preferred subjects, interests and/or career goals.

3. The method (100) according to claim 1, wherein the clustering algorithm is a Graph Neural Network (GNN)-based architecture, comprising a plurality of GNN layers configured to perform node representation learning, capturing the attributes and relationships of various entities in a graph structure; the graph structure comprises nodes and edges; and wherein the nodes comprises features including student, subject, topic, and/or teacher attributes; and wherein the edges comprises relationships between the nodes.

4. The method (100) according to claim 3, wherein the plurality of GNN layers comprise node features, aggregation, and node update; and wherein the node features include initial node feature representations; and wherein the aggregation includes neighborhood aggregation to gather information from connected nodes; and wherein the node update includes update node representations based on the aggregated information.

5. The method (100) according to claim 1, wherein the clustering algorithm further comprises a prelection layer including prelection features and prelection update; and wherein the prelection features include extracted features from a prelection data, including topic, teacher and/or performance; and wherein the prelection update includes update prelection features based on the aggregated information; and wherein the prelection features are then combined with the node update of the plurality of GNN layers.

6. The method (100) according to claim 1, wherein the clustering algorithm also comprises an unsupervised learning layer configured to uncover hidden patterns and structures of the data, including information related to lectures or instructional content, and employs techniques, including clustering or dimensionality reduction to derive meaningful latent representations.

7. The method (100) according to claim 1, wherein the teacher output comprises predicted recommendations for teachers, including curated course content, optimal teaching methods, class summary, class attendance, overall class mood, average quiz results when applicable, and/or student engagement scores; and wherein the student output comprises predicted recommendations for students, including course selection, academic support, topics for self-learning and/or future-most optimum academic track, including potential career path and their associated options; and wherein the future-most optimum academic track is accomplished by using a clustering and classification based approach; and wherein the system output comprises valuable insights based on teacher and student predictions, and recommendations to optimize the learning environment and curriculum design.

8. The method (100) according to claim 7, wherein the method for generating a future-most optimum academic track comprises the steps of:
a. collecting a dataset comprising a plurality of attributes, including student ID, topic/subject names, performance scores or grades, learning path labels, names of professions, historical performance data of various topics or subjects, quizzes, assignments, and/or subject attendance;
b. pre-processing the dataset by handling missing values, removing outliers, and ensuring data consistency;
c. extracting features from the dataset to capture the student's performance in different topics;
d. applying hierarchical clustering to identify meaningful clusters and learning paths of the extracted features of the students; and wherein the hierarchical clustering is to create a hierarchy of clusters based on similarity of student's performance in different topics;
e. determining an optimal number of clusters that strikes a balance between granularity and interpretability, to understand the structure of the data and identify meaningful learning paths and topic groups;
f. assigning cluster labels to each student based on the resulting cluster assignments;
g. training a classification model using the historical performance data and the assigned cluster labels as input features;
h. evaluating the performance using appropriate evaluation metrics, including accuracy, precision, recall, F1-score, and/or area under the Receiver operating Characteristic (ROC) curve (AUC-ROC);
i. refining and fine-tuning hyperparameters, adjusting feature selection techniques, or exploring different clustering parameters;
j. predicting the learning paths and topic proficiencies of new students, by inputting the historical performance data, obtaining predictions, and using the assigned cluster labels to recommend suitable learning paths or topic groups based on the predicted outcomes;
k. continuously updating and retraining the method as new data becomes available; and
l. incorporating feedback and monitoring to ensure effectiveness in predicting the learning paths and topic proficiencies based on historical performance data.

9. A computer-implemented system (200) for adaptive student performance evaluation, the system comprising:
a. an input module (202) configured to acquire an input data comprising student history, current study data, microphone input, camera input, teacher teaching methods, and learning path parameters from a user; and wherein the user includes a teacher and a student;
b. an application server (204) configured to receive the input data from the input module;
c. a multi-output algorithmic module (206) comprising a plurality of algorithms including a clustering algorithm and a multi-output machine learning algorithm, configured to obtain the input data from the application server (204) and process the input data to provide an output data to the user; and
d. an output data module (208) configured to receive the output data from the application server (204), and to provide the output data comprising a teacher output, a student output, and a system output.

10. The system (200) according to claim 9, wherein the student history includes previous subjects and topics covered; and wherein the current study data includes current subjects and topics being studied; and wherein the microphone input includes audio input from a microphone capturing the student's speech and/or tone, active talk time and/or class participation; and wherein the camera input includes visual input from a camera capturing student's facial expressions and/or body language; and wherein the teacher teaching methods include information on teacher's instructional strategies, approaches and techniques; and wherein the learning path parameters include user-defined parameters for learning path customization, including preferred subjects, interests and/or career goals.

11. The system (200) according to claim 9, wherein the clustering algorithm of the multi-output algorithmic module (206) is a Graph Neural Network (GNN)-based architecture, comprising a plurality of GNN layers configured to perform node representation learning, capturing the attributes and relationships of various entities in a graph structure; the graph structure comprises nodes and edges; and wherein the nodes comprises features including student, subject, topic, and/or teacher attributes; and wherein the edges comprises relationships between the nodes.

12. The system (200) according to claim 11, wherein the plurality of GNN layers comprise node features, aggregation, and node update; and wherein the node features include initial node feature representations; and wherein the aggregation includes neighborhood aggregation to gather information from connected nodes; and wherein the node update includes update node representations based on the aggregated information.

13. The system (200) according to claim 9, wherein the clustering algorithm of the multi-output algorithmic module (206) further comprises a prelection layer including prelection features and prelection update; and wherein the prelection features include extracted features from a prelection data, including topic, teacher and/or performance; and wherein the prelection update includes update prelection features based on the aggregated information; and wherein the prelection features are then combined with the node update of the plurality of GNN layers.

14. The system (200) according to claim 9, wherein the clustering algorithm of the multi-output algorithmic module (206) also comprises an unsupervised learning layer configured to uncover hidden patterns and structures of the data, including information related to lectures or instructional content and employing techniques, including clustering or dimensionality reduction to derive meaningful latent representations.

15. The system (200) according to claim 9, wherein the teacher output comprises predicted recommendations for teachers, including curated course content, optimal teaching methods, class summary, class attendance, overall class mood, average quiz results when applicable, and/or student engagement scores; and wherein the student output comprises predicted recommendations for students, including course selection, academic support, topics for self-learning and/or future-most optimum academic track, including potential career path and their associated options; and wherein the future-most optimum academic track is accomplished by using a clustering and classification based approach; and wherein the system output comprises valuable insights based on teacher and student predictions, and recommendations to optimize the learning environment and curriculum design.

16. The system (200) according to claim 15, wherein the method for generating a future-most optimum academic track by the output module (208) comprises the steps of:
a. collecting a dataset comprising a plurality of attributes, including student ID, topic/subject names, performance scores or grades, learning path labels, names of professions, historical performance data of various topics or subjects, quizzes, assignments, and/or subject attendance;
b. pre-processing the dataset by handling missing values, removing outliers, and ensuring data consistency;
c. extracting features from the dataset to capture the student's performance in different topics;
d. applying hierarchical clustering to identify meaningful clusters and learning paths of the extracted features of the students; and wherein the hierarchical clustering is to create a hierarchy of clusters based on similarity of student's performance in different topics;
e. determining optimal number of clusters that strikes a balance between granularity and interpretability, to understand the structure of the data and identify meaningful learning paths and topic groups;
f. assigning cluster labels to each student based on the resulting cluster assignments;
g. training a classification model using the historical performance data and the assigned cluster labels as input features;
h. evaluating the performance using appropriate evaluation metrics, including accuracy, precision, recall, F1-score, and/or area under the Receiver operating Characteristic (ROC) curve (AUC-ROC);
i. refining and fine-tuning hyperparameters, adjusting feature selection techniques, or exploring different clustering parameters;
j. predicting the learning paths and topic proficiencies of new students, by inputting the historical performance data, obtaining predictions, and using the assigned cluster labels to recommend suitable learning paths or topic groups based on the predicted outcomes;
k. continuously updating and retraining the method as new data becomes available; and
l. incorporating feedback and monitoring to ensure effectiveness in predicting the learning paths and topic proficiencies based on historical performance data.
